(19) United States
(12) Patent Application Publication
(10) Pub. No.: US 2010/0155413 A1
(43) Pub. Date: Jun. 24, 2010

(54) METHOD AND APPARATUS FOR PEST BAIT APPLICATION

(76) Inventors: Kevin Shiplack, Montmartre (CA); Norman Englot, Montmartre (CA)

Correspondence Address: KING & SCHICKLI, PLLC, 247 NORTH BROADWAY, LEXINGTON, KY, 40507, US

(21) Appl. No.: 12/603,238

(22) Filed: Oct. 21, 2009

Related U.S. Application Data
(60) Provisional application No. 61/224,693, filed on Jul. 10, 2009.

(30) Foreign Application Priority Data
Oct. 22, 2008 (CA) 2,641,528

(51) Int. Cl. B65D 83/00; A01M 99/00; A01M 25/00

(52) U.S. Cl. 222/1; 222/394; 222/386; 43/1; 43/58

(57) ABSTRACT

An apparatus for applying bait to pest traps and a method of using the apparatus is provided. The apparatus has an elongate body having an interior cavity in communication with an opening at a first end of the body, a flowable pest bait pre-packaged and contained within the cavity, and a nozzle attached to the opening. A flowable bait is extruded on a bait pedal of a rodent trap by aiming the nozzle over a bait pedal of the rodent trap such that the user's hands remain out of reach of a spring-loaded bow of the rodent trap, and applying pressure to the flowable bait through the use of a plunger or the like. The user can then discard the apparatus.

This application claims the benefit of U.S. Provisional Patent Application Ser. No. 61/224,693, filed Jul. 10, 2009, the disclosure of which is incorporated by reference.

### FIELD OF THE INVENTION

This invention is in the field of pest traps and baits.

### BACKGROUND

Pests such as mice and rats can infest a building and pose a health and safety risk.

Oftentimes elimination of pests is done by way of pest traps such as traps for mice and rats. There are two basic types of pest traps: traps that poison the pest and traps that catch the pest.

Poison traps work by enticing the pest to ingest a poisoned food or bait and sometimes bring the poison back to the nest for the other pests to consume. The poison will eventually kill the pest. Poison traps, however, can pose a health risk to young children and non-targeted animals as they are poisonous not only to pests, but are usually toxic to humans and house pets as well. Furthermore, there is generally no way of knowing where and when the pests will consume the poisoned bait and die, and could end up dying inside walls of a house or elsewhere within a home without being discovered until much later. Traps that physically trap the pests may therefore be preferable.

The typical physical pest trap for a rat or a mouse is the metal “snap trap”. These rodent traps typically consist of a rectangular base attached to which is a heavily spring-loaded bow and a bait pedal. When set to trap a rodent, the spring-loaded bow is pulled back from a resting position and a tripping mechanism is set to release the bow upon disturbance of the bait pedal. Some kind of bait, usually food such as peanut butter or cheese, is placed on the bait pedal to attract the rodents.

In operation, the bait pedal is disturbed by a rodent grabbing or nibbling at the bait, which sets off the tripping mechanism. The tripping mechanism causes the spring-loaded bow to swiftly swing down toward the bait pedal with immense force. The force of the spring-loaded bow is generally great enough to kill the rodent instantly—the rodent is then trapped between the spring loaded bow and the rectangular base. The rodent can be discarded and the rodent trap can be reset for further use. Other types of physical traps include a type where bait is placed between two jaws, the jaws being snapped shut over the rodent when the tripping mechanism near the bait is disturbed.

Traditional rodent traps can be very effective in eliminating rat and mouse infestations, but can be dangerous to set up. When a rodent trap is set up to capture or kill a rodent, the bait is placed on the bait pedal to set off the tripping mechanism when the bait is disturbed. The mere movement of placing the bait on the bait pedal can trigger the tripping mechanism, causing the spring-loaded bow to swing down quickly and with force. If a person was placing a piece of bait onto the bait pedal with their fingers, their fingers could get caught between the spring-loaded bow and the rectangular base. The force of the spring-loaded bow on the person's fingers could cause serious damage; a rat trap being large enough to break a person's fingers. The force of the bow on human fingers is also very painful.

Setting of traditional rodent traps can also present a health concern. Oftentimes rodent traps are reused multiple times by discarding the dead rodent and resetting the trap. The used rodent trap would be dirty and could be covered in diseases and parasites from the dead rodent. After using a trap once, it is not desirable to bring any foodstuffs for human consumption (such as cheese or peanut butter) near the trap for fear of contaminating the food. It is therefore desirable to have a method and apparatus for baiting a pest trap that is safe and hygienic to use.

### SUMMARY OF THE INVENTION

It is an object of the present invention to provide a method and apparatus for baiting pest traps that overcome problems in the prior art.

In an embodiment, an apparatus for baiting pest traps comprises an elongate body having an interior cavity in communication with an opening at a first end of the body, a flowable pest bait pre-packaged and contained within the cavity, and a nozzle attached to the opening at the first end of the body.

A method for baiting pest traps comprises extruding a flowable bait on a bait pedal of a rodent trap with a container pre-filled with the flowable pest bait. The container has an elongate body with a hollow interior cavity in communication with an opening at a first end of the body, the flowable pest bait contained within the cavity, a nozzle attached to the opening at the first end of the body, and a combined length of the nozzle and elongate body longer than the scope of the pest trap so that if the tripping mechanism on the rodent trap is tripped a user's hands will not touch the rodent trap. The container is further configured such that a user can exert an expelling force on the exterior of the container and at a location remote from the nozzle, which creates pressure on the inside of the container body and forces the flowable pest bait out of the interior cavity, through the nozzle opening and nozzle, and onto the bait pedal of the pest trap.

In operation, a user first sets a tripping mechanism on a rodent trap. Holding the apparatus pre-loaded with flowable pest bait, the user aims the nozzle over a bait pedal of the rodent trap such that the user's hands remain out of reach of a spring-loaded bow of the rodent trap, but near enough such that any flowable bait coming out of the nozzle can be reasonably aimed to land only on the bait pedal. By applying pressure to the flowable bait through the use of a plunger or the like, the flowable bait is forced through the nozzle and is expelled out the nozzle. If the tripping mechanism of the rodent trap goes off while the flowable bait is being put on the bait pedal, the user's hands will be out of harm's way of the spring-loaded bow of the rodent trap. When the user feels that enough of the flowable bait has been placed on the bait pedal, the user ceases to put any more pressure on the flowable bait. This lack of pressure terminates the flow of the flowable bait out of the nozzle. The user can use the apparatus on other rodent traps until there is no more flowable bait left in the cavity. The user can then discard the apparatus.

The method and apparatus for baiting pest traps allows a person to safely apply bait to a rodent trap. The method and apparatus for baiting pest traps also allows a person to hygienically apply bait to a rodent trap. The apparatus is furthermore disposable—it can be used on the bait pedal and, regardless of whether the apparatus touches the trap, can be disposed of.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front view of one embodiment of an apparatus for baiting pest traps in accordance with the present invention;

FIG. 2 is a top sectional view of the apparatus of FIG. 1, along line AA′;

FIG. 3 is a front sectional view of the apparatus of FIG. 1, along line BB′;

FIG. 4 is a front perspective view of the apparatus shown in FIG. 1 showing how it is used with a pest trap;

FIG. 5 is a front sectional view of the apparatus of FIG. 1 along AA′ showing how it is used with a pest trap;

FIG. 6 is a front view of another embodiment of an apparatus for baiting pest traps in accordance with the invention;

FIG. 7 is a sectional view of the apparatus of FIG. 6 along line CC′;

FIG. 8 is a schematic illustration of the apparatus shown in FIG. 7 showing how it is used with a rodent trap; and

FIG. 9 is a flowchart illustrating the steps of one embodiment of the method of applying bait to a pest trap in accordance with the present invention.

### DETAILED DESCRIPTION OF THE ILLUSTRATED EMBODIMENTS

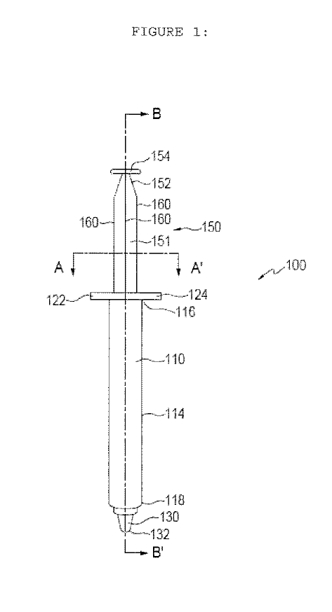

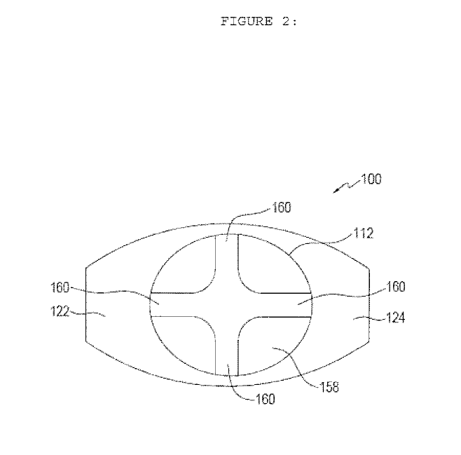

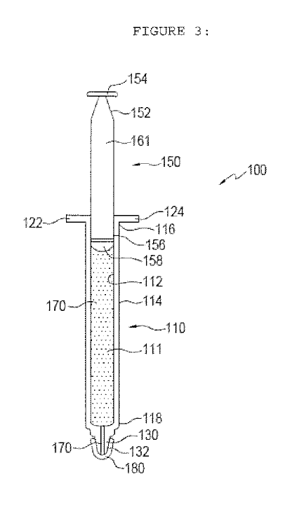

FIGS. 1 through 5 demonstrate one embodiment of an apparatus 100 for baiting pest traps in an embodiment of the present invention. Apparatus 100 has an elongate cylindrical body 110 consisting of a rigid material. Cylindrical body 110 has an inner surface 112, an outer surface 114, a first end 118, and a second end 116. The inner surface 112 defines an inner cavity 111 that is cylindrical in shape. The second end 116 of the cylindrical body 110 is provided with finger holds 122 and 124 which are molded integrally therewith and may extend radially and assume any size, shape or position. The first end 118 of the cylindrical body 110 is provided with a nozzle 130 such that the length of cylindrical body 110 and the nozzle 130 is longer than the reach of a pest trap. Nozzle 130 is preferably conical in shape, having a tapering outer surface 132 and a uniform inner cylindrical hollow 134 to allow materials to exit the first end 118 of the cylindrical body 110 into the cylindrical hollow 134 to be expelled.

The interior cavity 111 slidingly receives a plunger 150. The plunger 150 comprises a plunger body 151 and is provided at a first end 152 with a thumb pad 154 which extends outwardly from the interior cavity 111. A second end 156 of the plunger 150 is provided with a plug 158 which is adapted to closely engage the inner surface 112 of the cylindrical body 110 such that a seal is created between the plug 158 and the inner surface 112, but the plug 158 is still slidable against the inner surface 112 with a slight pushing force against the thumb pad 154 in the direction of the nozzle 130.

In an aspect, the plunger 150 is made in the form of radial wings 160 for the purpose of slidably guiding the plunger 150 in its motion relative to the inner surface 112 of the cylindrical body 110, while providing for lightness of weight and avoidance of excessive use of materials.

The interior cavity 111 is filled between the nozzle 130 and the plug 158 with a flowable pest bait 170. A cap 180 is provided to removably fit over the outer surface 132 of the nozzle 130, preventing the flowable pest bait 170 from flowing out through the nozzle 130 when the cap 180 is fitted on the nozzle 130.

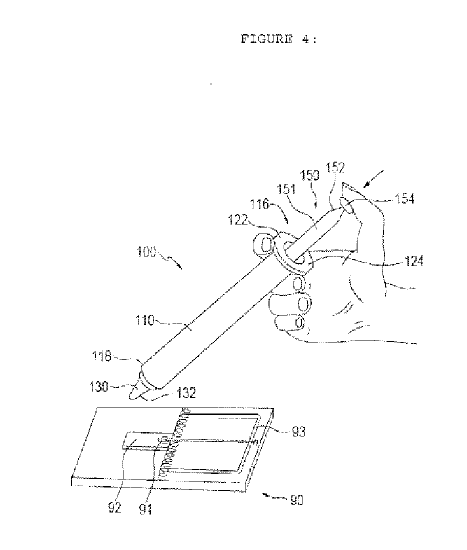

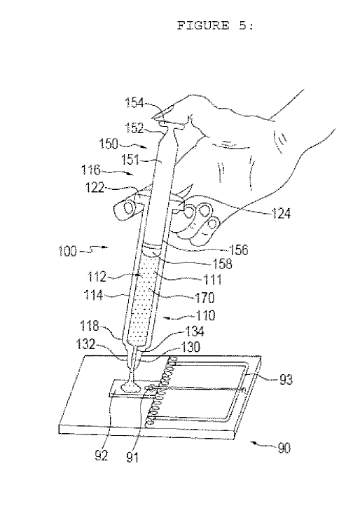

The typical physical pest trap for a rat or a mouse is the metal “snap trap”. These pest traps typically consist of a rectangular base attached to which is a heavily spring-loaded bow 93 and a bait pedal 92 (referring to FIGS. 4 and 5). When set to trap a rodent, the spring-loaded bow 93 is pulled back from a resting position and a tripping mechanism 91 is set to release the spring-loaded bow 93 upon disturbance of the bait pedal 92. Some kind of bait, usually food such as peanut butter or cheese, is conventionally placed on the bait pedal 92 to attract the rodents.

A user first sets the tripping mechanism 91 on the pest trap 90. The user then removes the cap 180 from the nozzle 130 of the apparatus 100 pre-loaded with flowable pest bait 170. The nozzle 130 is aimed over the bait pedal 92 of the pest trap 90 such that the user's hands remain out of reach of the spring-loaded bow 93 of the pest trap 90, but near enough such that the flowable bait 170 coming out of the nozzle 130 can be reasonably aimed to land only on the bait pedal 92. With a slight pushing of the thumb pad 154 by the user's thumb, the plunger 150 moves toward the second end 118 of the cylindrical body 110, with the plug 158 pushing up against the flowable bait 170. The force of the plug 158 against the flowable bait 170 will force the flowable bait 170 out the nozzle 130. If the tripping mechanism 91 of the pest trap 90 should go off while the flowable bait 170 is being put on the bait pedal 92, the user's hands will be out of harm's way of the spring-loaded bow 93 of the pest trap 90. When the user feels that enough of the flowable bait 170 has been placed on the bait pedal 92, the lack of pressure on the thumb pad 154 terminates the flow of the flowable bait 170 out of the nozzle 130. The user can then use the apparatus 100 on other pest traps until there is no more flowable bait 170 left in the interior cavity 111. The user can then discard the apparatus 100.

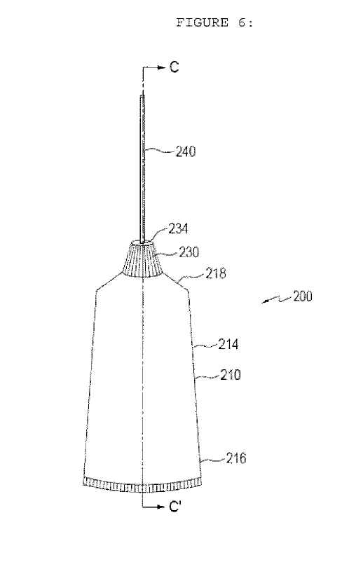

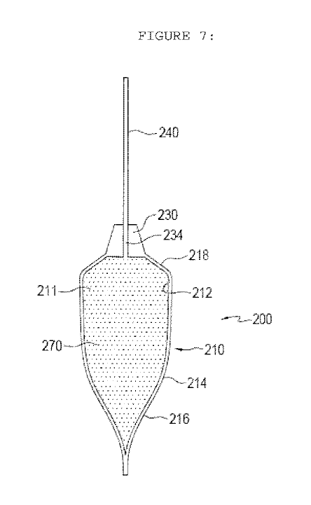

FIGS. 6 and 7 illustrate another embodiment of the present invention. Apparatus 200 comprises a body 210 with a uniform cross-section and an elongate cylindrical pipe 240. Body 210 is made out of a flexible material and is defined by an inner surface 212, an outer surface 214, a first end 218, and a second end 216. Inner surface 212 defines an interior cavity 211. The second end 216 of the body 210 is sealed. The interior cavity 211 is filled with a flowable pest bait 270 from the first end 218 to the second end 216 of the body 210. The flexible material of the body 210 is deformable upon exertion of a force on the outer surface 214 of the body 210 to create pressure inside the body 210, which forces the flowable pest bait 270 out of the interior cavity 211 through the first end 218. The first end 218 of the body 210 is provided with a cap 230 screwed tightly onto the first end 218. Cap 230 creates a seal with the first end 218 and has an inner cylindrical hollow 234. Inner cylindrical hollow 234 is receivable to an elongate cylindrical pipe 240 such that the pipe can be fitted securely into the inner cylindrical hollow 234, extending into the interior cavity 211 of the body 210 to allow materials to exit the first end 218 of the body 210 into the pipe 240 to be expelled. The length of the pipe 240 is sufficient to be longer than the reach of a pest trap.

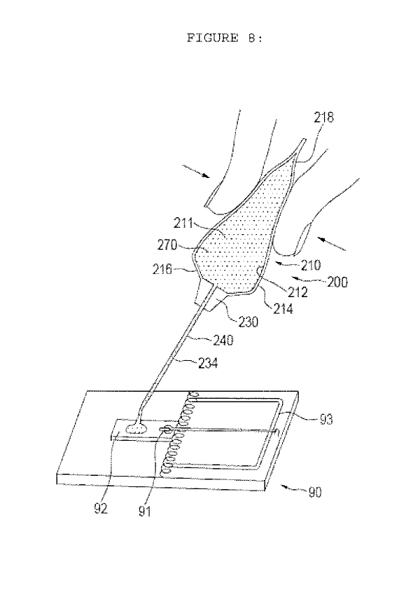

FIG. 8 illustrates the apparatus of Figures and 6 in use. The user first sets the tripping mechanism 91 on pest trap 90. In operation, a user holds the apparatus 200 pre-loaded with flowable bait 270 with their fingers at the body 210. The user aims the pipe 240 over the bait pedal 92 of the pest trap 90 such that the user's hands remain out of reach of the spring-loaded bow 93 of the pest trap 90, but near enough such that the flowable bait 270 coming out of the pipe 240 can be reasonably aimed to land only on the bait pedal 92. By applying a slight force on the body 210, the inner surface 212 of the body 210 draws in to make the interior cavity 211 smaller. This forces the flowable bait 270 into the pipe 240 to be expelled out of the pipe 240 and onto the bait pedal 92. If the tripping mechanism 91 of the pest trap 90 should go off while the flowable bait 270 is being put on the bait pedal 92, the user's hands will he out of harm's way of the spring-loaded bow 93 of the pest trap 90. The user can reset the pest trap 90 and continue to bait the bait pedal 92. When the user feels that enough of the flowable bait 270 has been placed on the bait pedal 92, the user ceases to apply force. The lack of pressure on the body 110 terminates the flow of the flowable bait 270 out of the pipe 240. The user can then use the apparatus 200 on other rodent traps until there is no more flowable bait 170 left in the interior cavity 211. The user can then discard the apparatus 200.

In addition to the apparatus for applying pest bait outlined herein, the invention also comprises the method of application of bait to a pest trap using the apparatus of the present invention. The method comprises the steps of setting the tripping mechanism of a pest trap having a bait pedal and then applying flowable pest bait to the bait pedal of the trap using a sealed container pre-filled with a flowable pest bait having a body with an interior cavity in communication with a nozzle opening in the body, flowable pest bait contained within the interior cavity, and a nozzle attached to the nozzle opening so that when an expelling force is exerted at a location remote from the nozzle, pressure is created inside the body that forces the flowable pest bait out of the interior cavity through the nozzle opening and nozzle, and onto a bait pedal of a pest trap that is configured to set off a tripping mechanism.

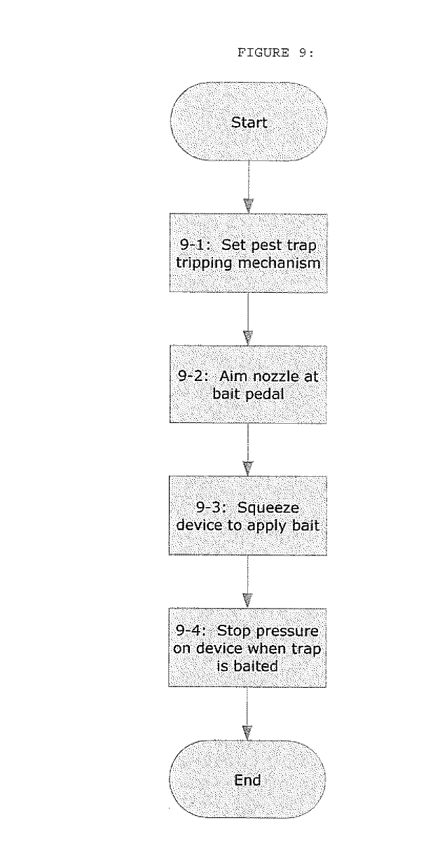

FIG. 9 demonstrates the basic method of the present invention. The apparatus which would be used in the conduct of the method of FIG. 9 could either be the “plunger” type body of the apparatus of FIGS. 1 through 5, or the “deformable tube” configuration demonstrated in FIGS. 6 through 8.

In any event, the first step of the method of the present invention is to set the tripping mechanism of a pest trap, exposing a bait pedal or bait application area, shown at step 9-1. Next, the nozzle of the bait applicator is aimed at the bait pedal of the pest trap, shown at step 9-2. Upon exertion of an expelling force on the exterior of the applicator, pressure is created inside the body and forces the flowable pest bait out of the interior cavity through the nozzle opening and nozzle and onto the bait pedal, shown at step 9-3. When sufficient bait has been expelled onto the bait pedal, the consumer ceases to put pressure on the exterior of the container, shown at step 9-4.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An apparatus for applying bait to pest traps, the apparatus comprising:
a body having an interior cavity in communication with a nozzle opening in the body;
a flowable pest bait contained within the interior cavity; and
a nozzle attached to the nozzle opening;
wherein the apparatus is configured to allow an operator to exert an expelling force on an exterior of the apparatus to create pressure inside the body and force the flowable pest bait out of the interior cavity through the nozzle opening and nozzle and wherein the apparatus is configured such that an operator can exert the expelling force at a location remote from the nozzle.

2. The apparatus of claim 1 wherein a cap is provided that removably fits over the outer surface of the nozzle, preventing the flowable pest bait from flowing out through the nozzle.

3. The apparatus of claim 2 wherein the nozzle is conical in shape.

4. The apparatus of claim 1 wherein the body is made of a rigid material.

5. The apparatus of claim 4 wherein the body is elongate and defines an elongate interior cavity.

6. The apparatus of claim 5 comprising a plunger opening in communication with the interior cavity at an end of the elongate body opposite the nozzle opening, and a plunger with an inside end slidable inside the interior cavity and an outside end extending to an exterior of the body, wherein the flowable pest bait is located between the inside end of the plunger and the nozzle opening, and wherein the inside end of the plunger includes a seal between the plunger and walls of the interior cavity.

7. The apparatus of claim 6 wherein finger holds extend laterally to the body adjacent to the plunger opening.

8. The apparatus of claim 1 including an extension pipe attached to the nozzle.

9. The apparatus of claim 1 wherein the body is made out of a flexible material and wherein the operator exerts a force on an exterior of the flexible body to deform the body to create pressure inside the body and force the flowable pest bait out of the interior cavity through the nozzle opening and nozzle.

10. The apparatus of claim 9 wherein the body is elongate and the nozzle is located on an end of the elongate body and where the body tapers toward the nozzle.

11. A method for applying bait to a pest trap using a sealed container pre-filled with a flowable pest bait, the container comprising:
a body having an interior cavity in communication with a nozzle opening in the body;
the flowable pest bait contained within the interior cavity;
a nozzle attached to the nozzle opening; and
whereby the container is configured such that an operator can exert an expelling force at a location remote from the nozzle;
providing a pest trap with a bait pedal configured to set off a tripping mechanism; and
exerting the expelling force on an exterior of the container to create pressure inside the body and force the flowable pest bait out of the interior cavity through the nozzle opening and nozzle, and onto the bait pedal.

12. The method of claim 11 comprising covering the outer surface of the nozzle to prevent the flowable pest bait from flowing out through the nozzle.

13. The method of claim 12 wherein the nozzle is conical in shape.

14. The method of claim 11 wherein the body is made of a rigid material.

15. The method of claim 14 wherein the body is elongate and defines an elongate interior cavity.

16. The method of claim 15 wherein the container comprises a plunger opening in communication with the interior cavity at an end of the elongate body opposite the nozzle opening, and a plunger with an inside end slidable inside the interior cavity and an outside end extending to an exterior of the body, wherein the flowable pest bait is located between the inside end of the plunger and the nozzle opening, and wherein the inside end of the plunger includes a seal between the plunger and walls of the interior cavity.

17. The method of claim 16 wherein finger holds extend laterally to the body adjacent to the plunger opening.

18. The method of claim 11 wherein said container includes an extension pipe attached to the nozzle.

19. The method of claim 18 wherein the body is made out of a flexible material and a force is exerted on an exterior of the flexible body to deform the body to create pressure inside the body and force the flowable pest bait out of the interior cavity through the nozzle opening and nozzle.

20. The method of claim 19 wherein the body is elongate and the nozzle is located on an end of the elongate body and where the body tapers toward the nozzle.
